(19) United States
(12) Patent Application Publication
(10) Pub. No.: US 2012/0002905 A1
(43) Pub. Date: Jan. 5, 2012

(54) Dual Pouch Bag

(76) Inventor: Daniel L. Banagas, Menifee, CA (US)

(21) Appl. No.: 13/175,814

(22) Filed: Jul. 1, 2011

Related U.S. Application Data
(60) Provisional application No. 61/360,926, filed on Jul. 2, 2010.

(51) Int. Cl. B65D 30/22; B31B 21/00

(52) U.S. Cl. 383/40; 493/210

(57) ABSTRACT

A dual pouch bag package and method of making it in which a primary flat type of bag packaging is fused together with a rear panel, creating a secondary pouch on the rear of the primary pouch. The rear panel extends across the rear section of the primary pouch and the side edges are fused together to the rear of the primary pouch by heat seal method. The rear panel forms a pouch and the right and left edge are folded inward, creating a crease that allows the rear panel to flatten downward onto the rear of the primary pouch. The top and bottom edges of the rear panel are fused to the rear of the front primary pouch by the heat sealing method. A single hole or multiple holes in the upper band for receiving support members for transporting the dual pouch bag during manufacture or for displaying the dual pouch bag at the marketplace.

### TECHNICAL FIELD

Certain embodiments of the present disclosure generally relate to bag packaging and, more particularly, to a dual pouch bag system that is one unit.

### BACKGROUND

A large variation of products are marketed in flexible plastic bags which are referred to as flat bags because in their empty stage they are in a flat condition. Such flat bags are used for a variety of products such as seeds, powder, grains, liquids and many other types of products.

There is a special need for dual pouch bag packaging which can be filled with two different product items and contained as one single bag unit. For example, sunflower seeds could be placed whole in the primary front flat pouch, and the rear, secondary pouch could be sealed closed empty. After the consumer opens the dual pouch packaging they can take whole seeds from the primary front pouch, then, crack the seed shells open and dispense of the empty cracked seed shells into the secondary rear pouch.

Unfortunately, most bag products are not comprised of a dual pouch bag system and cannot utilize the secondary rear pouch for either filling with an additional product, or for use as an auxiliary container to place items such as cracked open sunflower seed shells or pistachio seed shells, or similar other seed and nut products.

### SUMMARY OF THE DISCLOSURE

Certain embodiments provide a method for producing a dual pouch bag consisting of a secondary pouch attached to a standard flat bag pouch.

Certain embodiments provide a method of adding a rear panel to an existing standard flat bag product by heat sealing and fusing the edges of the upper and lower sections of the dual pouch bag which form a unitary bag product.

### DESCRIPTION OF THE DRAWING

So that the manner in which the above recited features of the present disclosure and be understood in detail, a more particular description of the disclosure, briefly summarized above, may be had by reference to embodiments, some of which are illustrated in the appended drawing. It is to be noted, however, that the appended drawing illustrates only typical embodiments of this disclosure and are therefore not to be considered limiting of its scope, for the disclosure may admit to other equally effective embodiments.

FIG. 1 illustrates an example of a dual pouch bag, in accordance with certain embodiments of the present disclosure.

### DETAILED DESCRIPTION

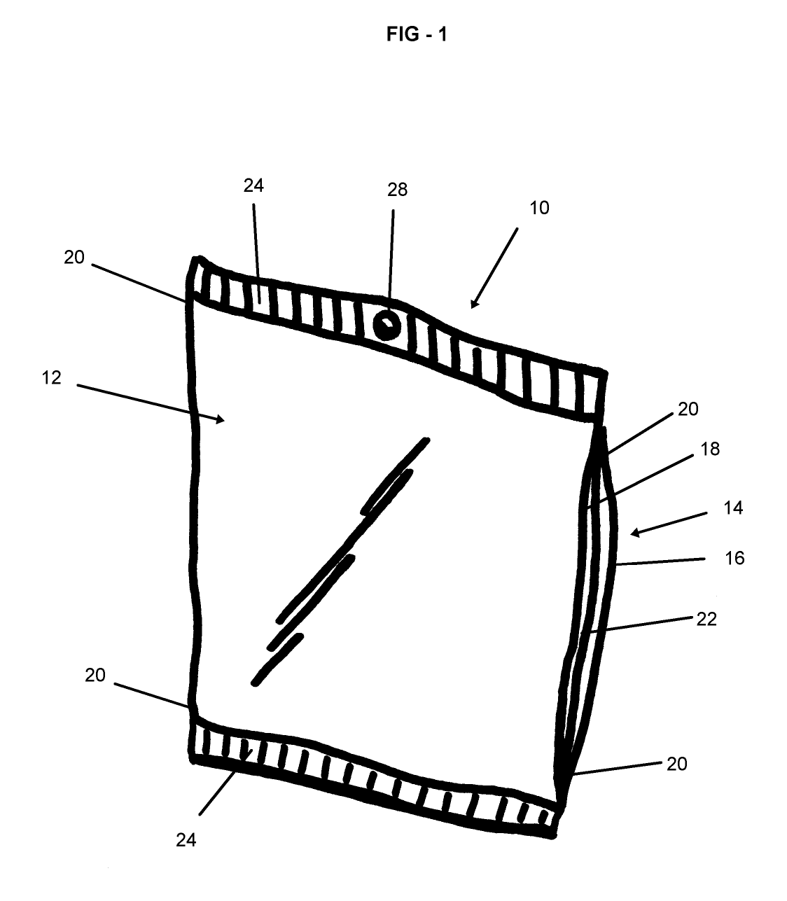

Referring to the drawing in FIG. 1 the double pouch bag embodying the invention is designated generally at 10 and comprised of two pouches 12 and 14 joined together at the rear by the addition of a secondary rear panel 16. Pouch 12 is the primary pouch and pouch 14 is the secondary pouch. Pouch 12 is made up of an industry standard flat rectangular bag package. Pouch 14 is made by the placement of an additional rear panel 16 that is placed over the back section 18 of primary pouch 12. Pouch 12 and 14 are joined together by heat fusing a rear panel 16 to the back section 18 of primary pouch 12.

The primary pouch 12 is produced in the normal fashion, with some exceptions, on a horizontal flat bag machine. The rear panel 16 is folded in and gusseted 22 on both, the right and left sides. Each top and bottom section 20 of rear panel 16 is joined together to primary pouch 12 by pressure and heat fusing which closes and seals pouch 14. In joining together and sealing top and bottom sections 20 by pressure and heat fusion, an upper and lower horizontal band 26 and 24 is formed in the packaging. By applying pressure and heat fusing upper and lower sections 20 horizontally, a gusset 22 is formed at middle of secondary pouch 14. Creating a gusset 22 allows for the expansion and contraction of the secondary pouch 14. The upper heat fused band 24 contains an aperture 18 in the middle for hanging merchandise at store locations on pegs. An additional aperture 18 may also be added to the upper band 24, equally spaced apart from each other, to facilitate the use of pegs with certain automated manufacturing packaging equipment.

1. A method for containing two product items in separate pouch sections within the same single bag unit. A dual pouch package comprised of a primary and secondary pouch. The primary pouch is industry standard flat bag packaging. The secondary pouch formed by the addition of a panel placed across the rear section of the primary pouch. The additional panel is larger in size than the rear panel of the primary pouch which it is being attached to. Pressure and heat fusing of the panel at left and right edges fuses the panel to the rear side of the primary pouch. A gusset created in the secondary pouch allows for expansion and contraction of the pouch.

2. The method of claim #1 wherein the secondary pouch is created by attaching an additional panel across the rear section of the primary flat pouch packaging.

3. The method of claim #2 wherein the addition of a larger rear panel comprising the secondary pouch, a space or gap is created to form the secondary pouch.

4. The method of claim #1 wherein the left and right side edges of the additional panel, which is placed over the rear section of the primary pouch, is heat fused with pressure to fuse the panel together to the primary pouch.

5. The method of claim #1 wherein the side edge sections of the additional panel, which is placed over rear section of the primary pouch, are folded and creased inward then fused together at upper and lower end sections by pressure and heat fusing method.

6. The method of claim #5 wherein a gusseted crease is created by the folding in of the side edge sections of the additional rear panel.

7. The method of claim #5 wherein pressure and heat fusing of left and right sides, and upper and lower sections of rear panel are sealed, thus producing a pouch.

8. The method of claim #5 wherein pressure and heat fusing of upper and lower sections forms a band at the top and bottom of the bag package.

9. The method of claim #8 wherein an aperture or apertures can be added to facilitate the hanging or carrying of said dual pouch bag package.

10. The method of claim #1 wherein said primary pouch is filled with a product, but the secondary pouch may or may not be filled before being heat fused together with pressure.
